(19) United States
(12) Patent Application Publication
(10) Pub. No.: US 2010/0077799 A1
(43) Pub. Date: Apr. 1, 2010

(54) Manufacturing Method of Lens and Lens

(75) Inventors: Kazunari TADA, Marugame-shi (JP); Takashi Sannokyou, Tokyo (JP); Shuhei Ashida, Tokyo (JP)

Correspondence Address: COHEN, PONTANI, LIEBERMAN & PAVANE LLP, 551 FIFTH AVENUE, SUITE 1210, NEW YORK, NY, 10176, US

(73) Assignee: Konica Minolta Opto, Inc., Tokyo (JP)

(21) Appl. No.: 12/565,607

(22) Filed: Sep. 23, 2009

(30) Foreign Application Priority Data
Sep. 30, 2008 (JP) JP2008-255761

(51) Int. Cl. C03B 11/00

(52) U.S. Cl. 65/66

(57) ABSTRACT

Since a lens droplet contacts with an outer shape regulation frame 3 at an early stage and is formed to be a glass lens 100 by pressure in a fluidized state with less deformation, a positioning datum surface 102b and so forth can be formed accurately. Also, as a result that the melt droplet contacts with the outer shape regulation frame 3 at the early stage, a shape of a side surface 103 of the glass lens 100 can be formed accurately, and centering process after formed can be omitted.

This application is based on Japanese Patent Application No. 2008-255761 filed on Sep. 30, 2008, in Japanese Patent Office, the entire content of which is hereby incorporated by reference.

### TECHNICAL FIELD

The present inventions relates to a manufacturing method of a lens and a lens obtained by the method thereof, and in particular, to a manufacturing method of a lens formed by hardening glass in a liquid droplet form.

### BACKGROUND

As a manufacturing method of a glass lens, there is a method using a lower mold to which an outer shape regulating member having an outer shape regulating surface of the lens is integrated and an upper mold opposing the lower mold (Patent Document 1: Unexamined Japanese Patent Application Publication No. 2004-339039). In the above manufacturing method, melted glass is dropped on a heated surface of the lower mold and spread by impact so that the glass contacts the outer shape regulation surface, whereby a positioning datum surface of a circumferential section of the lens is molded. Then, while the glass is still at a temperature where the glass can be deformed by pressure, the glass is subject to pressure molding by the upper and lower molds and a lens having two surfaces i.e. two optical functional surfaces and a positioning datum surface is obtained.

Patent Document 1: Unexamined Japanese Patent Application Publication No. 2004-339039

However, in the above manufacturing method, since the outer shape regulation member is integrated with the lower mold, in case the melted glass droplet does not contact with the outer shape regulation surface immediate after the melt glass drops, the melt glass droplet contacts with the upper mold first then spreads laterally and stays inside the outer shape regulation member at a final stage. Thus, there is occurred a tendency that shape accuracy of the positioning datum surface in respect to the circumferential side near the outer shape regulation member in the low mold surface of the lower mold is deteriorated.

An object of the present invention is to provide a lens manufacturing method which enables accurate forming of the positioning datum surface even in case the melt glass droplet does not spread to a large extent laterally immediately after the meld glass droplet drops and the droplet contacts with the upper mold first when both the molds move close to each other.

### SUMMARY

To resolve the above problems, the manufacturing method reflecting one aspect of the present invention, includes steps of: preparing a lower mold having a lower mold surface to form a first lens surface of a lens representing an object of manufacturing, an upper mold having an upper mold surface to form a second lens surface of the lens and an outer shape regulation frame having an outer shape regulation surface to form an outer shape including a side surface of the lens; dropping a melt glass droplet on the lower mold surface in a state where the lower mold, the upper mold and the outer shape regulation frame are heated, which represents a dropping process; and molding the melt glass droplet on the lower mold with pressure by moving the upper mold and the outer shape regulation flame close to the lower mold in a state where the lower mold surface and the upper mold surface face each other after dropping the melt glass droplet, which represents a forming process.

In the above manufacturing method of the lens, in the molding process after the dropping process, since the melt glass droplet on the lower mold is subject to pressure molding by moving the outer shape regulation frame close to the lower mold along with the upper mold, even in case the melt glass droplet does not spread to a large extent laterally immediately after the meld glass droplet drops and the droplet contacts with the upper mold first, the melt glass droplet which has contacted with the upper mold contacts the outer shape regulation frame at an early stage of closing the molds. Whereby, since the lens is pressed in a fluidized state without losing shape to a large degree, the positioning datum surface can be molded accurately. Also, as the result that the melt glass droplet contacts with the outer shape regulation frame at the early stage, the side surface of the lens can be formed accurately and centering process after molding can be omitted.

Also according to an embodiment of the present invention, since the outer shape regulation frame is fixed at a barrel section of the upper mold, the position of the outer shape regulation frame in respect to the upper frame can be maintained readily.

### BRIEF DESCRIPTION OF THE DRAWINGS

FIG. 1 is to describe a cross-sectional structure of a metal mold used in manufacturing a glass lens related to the present invention.

FIG. 2 is a magnified view of a relevant portion of a metal mold.

FIG. 3 is a partially magnified view to describe a glass lens.

FIG. 4 is a cross sectional view to describe a process of glass lens manufacturing using a metal mold.

FIGS. 5A and 5B are cross sectional views to describe each process of glass lens manufacturing using a metal mold.

FIGS. 6A to 6E are diagrams to schematically describe pressure molding of a glass lens.

FIGS. 6F to 6J are for comparison.

FIG. 7 is a schematic diagram to indicate an exemplary design of a glass lens.

### DETAILED DESCRIPTION OF PREFERRED EMBODIMENTS

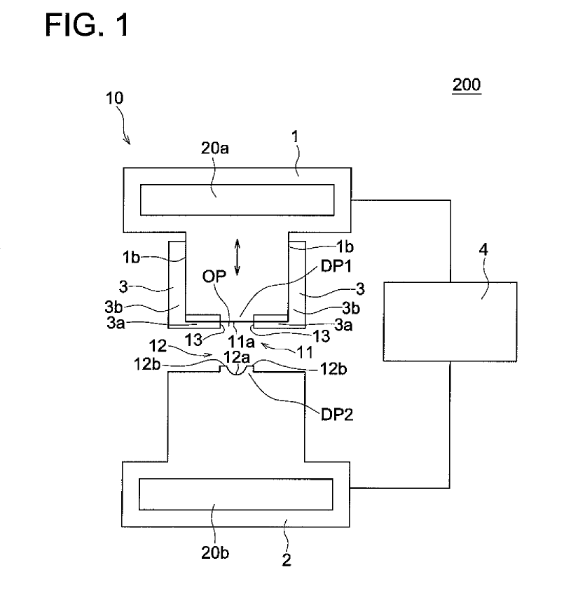

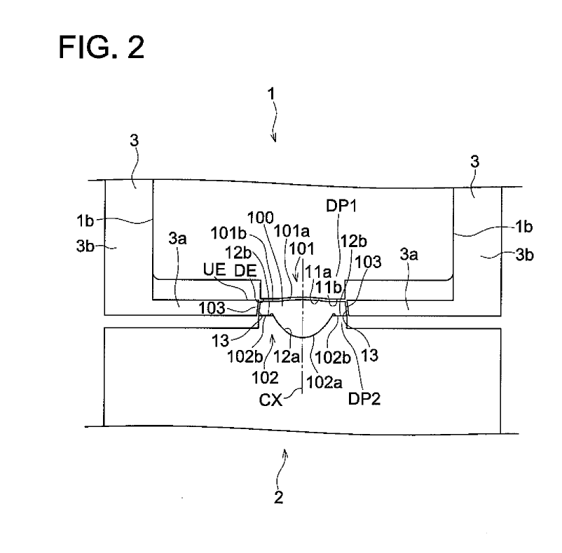

FIG. 1 describes a cross-sectional structure of the metal mold used in a glass lens manufacturing method related to a first embodiment. FIG. 2 is a magnified view of relevant portion of the metal mold, showing a glass lens formed by the metal mold related to the present embodiment.

A metal mold 10 related to the present embodiment produces a glass lens 100 shown by FIG. 2, through pressure molding where a glass material is melted and pressed directly, including an upper mold 1 having a transfer surface 11 representing an upper mold surface to form an optical function surface 101a of a relatively small curvature, a lower mold 2 having a transfer surface 12 representing a lower mold surface to form an optical function surface 102a of a relatively large curvature and an outer shape regulation frame 3 to form a side surface 103 of the glass lens 100 shown by FIG. 2. The transfer surface 12 of the lower mold 2 has a function to form a positioning datum surface 102b to be a base for positioning when the glass lens 100 is assembled with other members as an optical member, besides to form the optical function surface 102a. The outer regulation frame 3 also has a function to control flow of the glass laterally at time of pressure molding of the melted glass which is a material for the glass lens 100. In addition to the metal mold 100 representing a primary member, a control drive device 4 to open and close the upper mold 1 and the low mold 2 is provided for a manufacturing device 200 of the glass lens 100 to manufacture the glass lens 100.

The upper mold 1 is provided with a projection section DP1 having a transfer surface 11 at a lower end thereof to form one optical function surface 101a of the glass lens 100 and a circumferential surface 101b representing a plane surface in a periphery of the optical function surface 101a. Namely, the transfer surface 11 representing the upper mold surface is configured with a optical surface transfer surface 11a corresponding to each optical function surface 101a and a circumferential surface transfer surface lib corresponding to the circumferential surface 101b in a second lens surface 101 of the glass lens 100. Also, the upper mold 1 is able to move up and down through the control drive device 4 in a direction of an arrow in the figure, thereby moving up and down along a direction of a lens axis CX.

The lower mold 2 is provided with a projection section DP2 having a transfer surface 12 at an upper end thereof to form the other optical function surface 102a of the glass lens 100 and a positioning datum surface 102b in a periphery of the optical function surface 102a. Namely, the transfer surface 12 representing the lower mold surface is configured with an optical surface transfer surface 12a corresponding to each optical function surface 102a in a first lens surface 102 of the glass lens 100 and a datum surface transfer surface 12b corresponding to the positioning datum surface 102b.

An outer shape regulation frame 3 is a member to be fitted on the side surface section 1b representing a barrel section of the upper mold 1 and to be aligned which is, for example, formed of an ultrahard alloy. The outer shape regulation frame 3 is provided with a supporting member 3b in a shape of a cylinder fixed onto the upper mold 1 and a main body section 3a in a shape of a disc to form a surface of the glass lens 100 along with the projection section DP1. Here, the ultrahard alloy means an alloy including tungsten and carbon of which numbers of atoms are in a proportion of substantially 1:1, as well as cobalt (Co) which is 5-10%, in number of atoms. The main body section 3a is provided with the outer shape regulation surface 13 representing an inner surface of an opening OP so as to form the side surface 103 of the glass lens 100. The main body section 3a regulates movement of the melt glass to be the glass lens 100 at pressure molding of the glass, and controls the melt glass so as to possess a desirable surface shape (details will be described later). Also, since the outer shape regulation frame 3 is fixed at an appropriate position of the upper mold 1 through the supporting member 3b, the outer shape regulation surface 13 is in a state close to the transfer surface 11 of the upper mold 1. More specifically, an upper edge UE of the outer shape regulation surface 13 and a lower edge DE of the circumferential surface 11b of the transfer surface 11 are disposed closely with a minimal gap to which the melt glass material of the glass lens 100 cannot enter. Also, the outer shape regulation surface 13 is disposed coaxially in respect to the transfer surface 11 of the upper mold 1 and the transfer surface 12 of the lower mold 2 at pressure molding so as to maintain an appropriate positional relation.

The upper mold 1 and the lower mold 2 have electric heaters 20a and 20b built-in to heat the transfer surface 11, the outer shape regulation surface 13 and the transfer surface 12.

The control drive device 4 controls electric supply to the electric heaters 20a and 20b for forming glass lens 100 by the metal mold 10, and performs control of an entire manufacturing apparatus 200 in which metal mold 100 is integrated such as opening and closing of the upper mold 1 and lower mold 2.

Here, the glass lens 100 manufactured by the manufacturing apparatus 200 is a lens used in, for example, a pick-up. In recent years, a higher numeric aperture is desired for the pick-up lens so as to enhance a resolution. Thus for the optical function surfaces 101a and 102a which serve as optical surfaces of the glass lens 100, the curvature of one lens surface is configured to be extremely larger that the curvature of the other lens surface, and to avoid false forming due to remaining air, the lens is manufactured with the large curvature optical function surface 102a side faced downward. Namely, in the metal mold 10, the optical surface transfer surface 12a of the lower mold 2 has the large curvature and the optical surface transfer surface 11a of the upper mold 1 is almost flat.

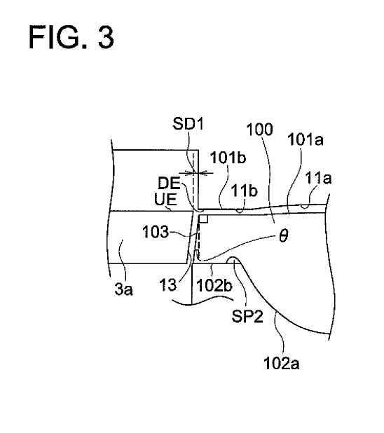

FIG. 3 is partially magnified to describe a relevant portion of the metal mold 10 and the shape of the glass lens 100. As the figure shows, in the upper mold 1 and the outer shape regulation frame 3 of the metal mold 10, the upper edge UE of the outer frame regulation surface 13 and the lower edge DE of the circumferential surface lib of the transfer surface 11 are disposed closely with a minimal gap between them. Namely, between the outer shape regulation frame 3 and the main body section 3a, there is formed a gap SD1 to purge air when the glass lens 100. Incidentally, the gap SDI has a width of approximately 1 to 20 μm which is a sufficient size to purge air and to prevent the melt glass material of the glass lens 100 from flowing out. Whereby defective molding due to remaining air in a border of the outer shape regulation frame 3 and the upper mold 1 at molding can be securely avoided, and the second lens surface 101 and side surface 103 of the glass lens 100 can be unfailingly formed by the outer shape regulation frame 3 and the upper mold 1.

Also, at the time of pressure molding of the glass lens 100, the outer shape regulation surface 13 and the lower mold 2 are closed each other with a gap of approximately 1 to 20 pm between them. Therefore, in the above case, the outer shape regulation surface 13 and the side surface 103 of the glass lens 100 to be formed have substantially the same lateral width. Thus, the above configuration prevents the melt glass droplet form flowing out from the space surrounded by both the molds 1, 2 and the outer shape regulation frame 3 as much as possible while molding, and the glass lens can be formed infallibly.

Further, the outer shape regulation surface 13 is formed in a taper shape broadened towards the lower mold 2. Whereby the side surface 103 of the glass lens 100 molded by transferring the outer shape regulation surface 13 is in a taper shape which is broadened from the optical function surface 101a side to the optical function surface 102a side. Namely, in the cross-sectional view of FIG. 3, an inclination angle θ is not less than °. Thereby by ascending the upper mold 1, the lens can be brought out readily. Also, when this occurs, by leveraging a difference of the expansion coefficients such as linier expansion coefficients between the outer shape regulation frame 3 and the glass lens 100 after having been hardened the melt glass droplet representing material of the glass lens 100, the glass lens 100 can be released readily form the mold after cooling down. Namely the outer shape regulation frame 3 is formed with the ultrahard material as mentioned in the forgoing. Here, the linier expansion coefficient of the ultrahard material is around 4.6×10^{-6 [1}/K], which is smaller compared to the expansion coefficient of phosphate series glass of 7 to 8×10^{-6 [1}/K]. In the above case, the outer shape regulation frame 3 has the smaller expansion coefficient than that of the general glass such as phosphate series glass in addition to high accuracy and high rigidity. Thus, a gap between the glass lens 100 after cool down and the metal mold 10 such as the outer shape regulation frame 3 can be readily created and the glass lens 100 after cool down can be brought out readily.

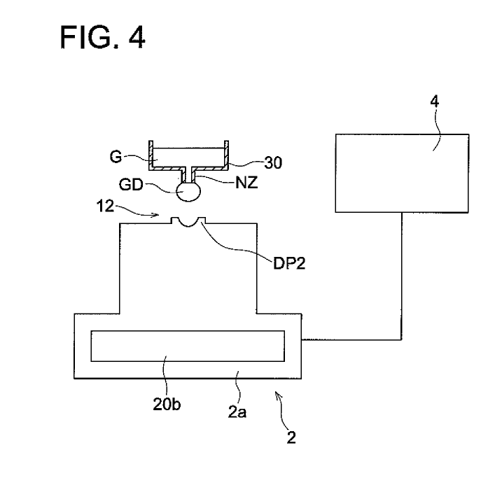

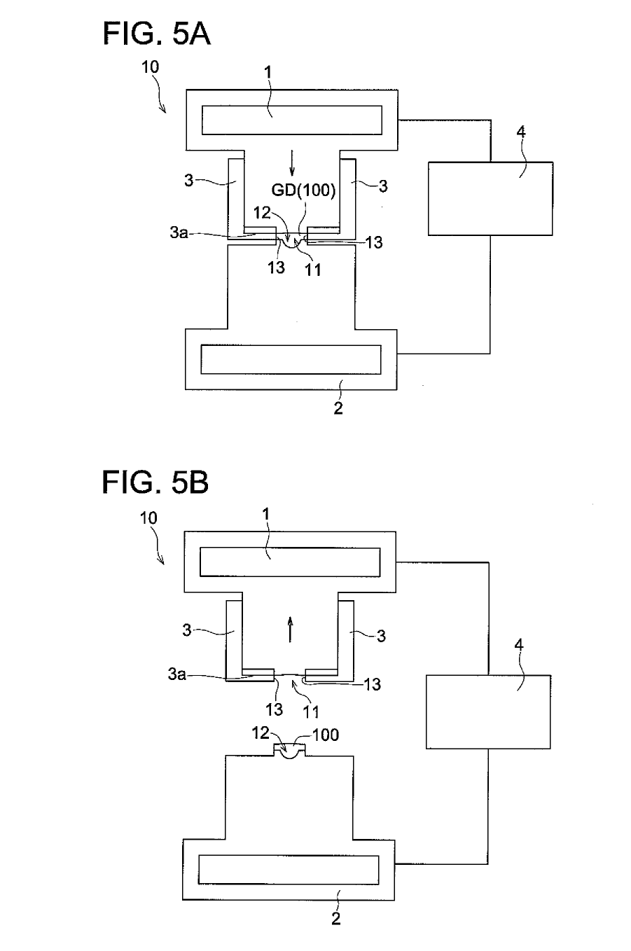

The manufacturing method of the glass lens 100 using the metal mold 10 will be described as follow. FIG. 4 and FIG. 5A and 5B are cross-sectional views to describe each process of manufacturing the glass lens 100 using the present metal mold.

First, as FIG. 4 shows, a melt glass A melted in an unillustrated crucible is reserved in a row material supply section 30. A nozzle NZ formed at a bottom part of the row material supply section 30 is brought above the transfer surface 12 of the lower mold 2 to the center thereof. Then a predetermined amount of the melt glass G drops from the nozzle NZ onto the transfer surface 12 by the gravity (dropping process).

When this occurs, before the melt glass G drops, the transfer surface 12 is heated by a heater 20b and the melt glass droplet GD representing the row material of the glass lens 100 is heated upto around a glass transition temperature T or the temperature range of (T−50° C.) to (T+100° C.) in advanced. When this occurs, before the melt glass G drops, the transfer surface 12 is heated by a heater 20b up to around a glass transition temperature T of the melt glass droplet GD representing the row material of the glass lens 100 or the temperature range of (T−50° C.) to (T+100° C.) in advanced. After dropping the melt glass, the nozzle NZ is retracted so as not to interfere with the upper molding 2 to move up and down. Through the glass supply method from the nozzle NZ by gravity fall, weight variation of the melt glass droplet GD to obtain the glass lens 100 can be regulated. As the row material glass used in the melt glass, for example, the phosphate series glass having the glass transition temperature of 477° C. can be applied.

After the predetermined amount of the melt glass droplet GD drops form the nozzle NZ onto the transfer surface 12, as FIG. 5A shows, while the melt glass droplet GD is still in a temperature where the droplet DG can be deformed by pressure, the upper mold 1 heated to a similar temperature to that of the lower mold in advance descends, then while facing the transfer surface 11 and the transfer surface 12 each other, the upper mold 1 and the outer shape regulation frame 3 fixed onto the upper mold 1 move closed to the lower mold 2 and the melt glass droplet GD on the lower mold 2 is subject to pressure molding between the upper and lower molds 1 and 2 (molding process).

By gradually decreasing the temperature of the melt glass droplet GD from the dropping process to the molding process, there is manufactured the glass lens 100 having the optical function surface 101a representing the second lens surface 101, the circumferential surface 101b, the optical function surface 102a representing the first lens surface 102, the positioning datum surface 102b and the side surface 103 of the glass lens 100. After sufficiently cool down the melt glass droplet GD, the pressure applied to the upper mold 1 and the lower mold 2 is relieved, and by ascending the upper mold 1 as FIG. 5B shows, the glass lens 100 having surfaces 101, 102 and 103 can be brought out (bringing out process).

In the above manufacturing method of the glass lens 100 of the present embodiment, because the metal mold 10 is provided with the outer shape regulation frame 3, the positioning datum surface 102b can be formed accurately in addition to the optical function surfaces 101a and 102a of the glass lens 100.

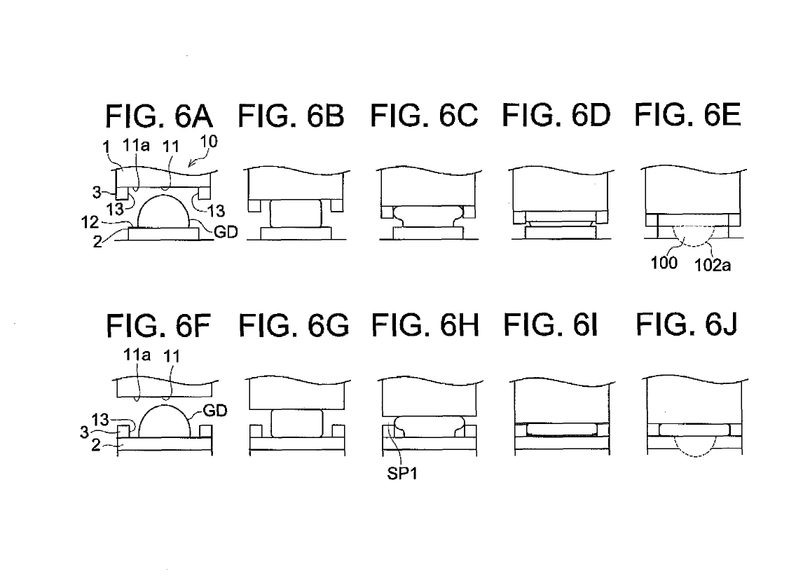

Processes to mold the glass lens 100, where the aforesaid melt glass droplet DG dropped is subject to pressure molding, will be described in details. FIGS. 6A to 5E are schematic diagrams to show pressure molding of the aforesaid glass lens, and FIGS. 6F to 6J are for comparison. Incidentally, in the present embodiment, as FIG. 2 shows, in the glass lens 100 obtained by the present embodiment, the curvature of the first lens surface 102 corresponding to the optical surface transfer surface 12a is greater than the curvature of the second lens surface 101. Therefore, a recess of the optical surface transfer surface 12a corresponding to the first lens surface 102 is large, thus the melt glass droplet GD immediate after dropping contacts the upper mold 1 first when both the molds 1 and 2 move close to each other without spreading laterally to a large extend.

Returning to FIG. 6A, based on the above conditions, pressure molding of the glass lens 100 will be described as follow.

First, as FIG. 6A shows, the meld glass droplet GD dropped is in a spherical shape. As mentioned above, the droplet GD is greatly affected by the shape of the optical surface transfer surface 12a (refer to FIG. 2) in the transfer surface 12, besides by a viscosity and a surface tension of the melt glass droplet GD. Next, as FIG. 6B shows, in the metal mold 10 the upper mold descents from above. Whereby the melt glass droplet GD in the spherical shape is squashed to be deformed and the optical function surface 102 having a large curvature located at a lower side of the surface shape of the glass lens 100 is formed (refer to FIG. 6E). Further, as FIG. 6C shows, when the upper mold 1 descends, the meld glass droplet GD spreads and extends to a periphery side of the upper mold 1 while adhering on the optical surface forming surface 11a. Namely, the melt glass droplet GD extends towards the outer shape regulation surface 13 located at the periphery side of the upper mold 1 along the optical surface forming surface 11a. Whereby the optical function surface 101a having small curvature located at an upper side is formed. Further as FIG. 6D shows, the meld glass droplet GD extended to the periphery side of the upper mold 1 encounters the outer shape regulation surface 13 and changes a direction of movement. Namely, flow of the melt glass droplet GD changes its direction from a lateral direction to a downward direction i.e. the melt glass droplet GD extends to the datum surface transfer surface 12b side of the transfer surface 12. Whereby, the side surface 103 is formed along the outer shape regulation surface 13. Further the melt glass droplet GD encounters the datum surface transfer surface 12b so that the positioning datum surface 102b corresponding to the datum surface transfer surface 12b is formed.

Incidentally, in the process of molding the glass lens 100, for example, as FIG. 3 shows, there is a case that the glass lens 100 is molded while spontaneously maintaining the space SP2 between the optical function surface 102a and the positioning datum surface 102b. Namely, in case a volume of the melt glass droplet GD is smaller than that of the space surrounded by both the molds 1, 2 and the outer shape regulation frame 3, a volume difference thereof becomes the space SP2. However, as far as the melt glass droplet GD maintains a volume not less than a certain lower limit, the space SP2 does not cause problems to the function of the glass lens 100. In the above case, since the volume of the melt glass droplet GD dropped has a tolerance that is from a certain lower limit to an upper limit which is the volume of the space surrounded by both the molds 1, 2 and the outer shape regulation fame 3, the space SP2 serves as a space to compensate the tolerance.

As above, the glass lens 100 is molded at a position shown by FIG. 6E. In the above case, the melt glass droplet GD contacts with the outer shape regulation frame 3 at an early stage and is pressed in a fluidized state without losing shape to a large degree so as to be a glass lens 100, whereby the positioning datum surface 102b can be molded accurately. Also, as the result that the melt glass droplet GD contacts with the outer shape regulation frame 3 at the early stage, the side surface 103 of the glass lens 100 can be formed in an accurate shape and a centering process after molding can be omitted.

Contrarily, for example, as an comparison example shown in FIG. 6F, in case the outer shape regulation frame 3 is installed at the lower mold 2, as FIGS. 6F to 6H shows, the melt glass droplet GD squashed and deformed by the upper mold 1 spreads and extends to the periphery side of the upper mold 1 while adhering on the transfer surface 11a, in the same manner as in FIGS. 6A to 6C. However, in the above case, as FIGS. 6H and 61 show, since the outer shape regulation surface 13 is located at a lower side, namely at the low mold side, a large space SP1 still exists between the transfer surface 11a and the outer shape regulation frame 3, even the upper mold 1 is lowered. Therefore, the flow of the meld glass droplet GD cannot always be controlled so as to immediately direct to a low side i.e. the transfer surface 12 side, and a downward flow of the melt glass along the circumferential side occurs. Namely, in the above case, even if the glass lens 100 is formed at a position shown by FIG. 6J, there is possibility that the positioning datum surface 102b cannot be formed accurately since the melt glass droplet GD cannot be sufficiently delivered across the transfer surface 12b because of increase of a viscosity of the melt glass droplet GD. On the other hand, in the manufacturing method of the glass lens 100 related to the present embodiment shows in FIGS. 6A to 6E, the above problems can be avoided.

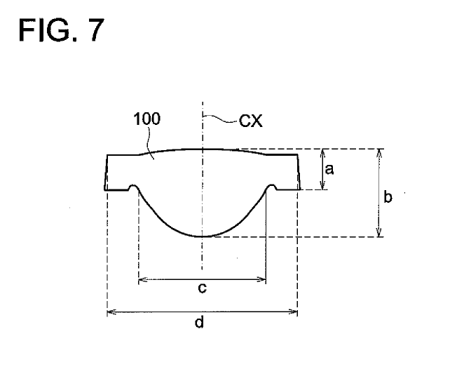

Incidentally, as specific dimensions of the glass lens 100, for example in FIG. 7, it is considered that as for a parallel direction to the lens axis CX, a dimensional ratio a/b of a side surface width a representing a width of the side surface 103 in respect to a thickness b of a total glass lens 100 is in the range of 0.1 to 0.4, and as for a perpendicular direction to the lens axis CX, a dimensional ratio c/d of an incident diaphragm diameter c representing a diameter of the optical function surface 102a of the first lens surface 102 to an outer shape dimension d of a total glass lens is in the range of 0.5 to 0.9. As more specific values, the side surface width a of 0.4 mm, the thickness width b of 1.4 mm, the incident diaphragm diameter c of 2.0 mm and the outer shape dimension d of 3.5 mm, are considered. By utilizing the manufacturing method of the glass lens 100 related to the present embodiment, the lens having a precise shape without a flaw can be formed in manufacturing of such small size lens as above.

Also, as an example of the above manufacturing, for example, the aforesaid phosphate series glass having the glass transition temperature T of 477° C. is used. In the above case, the glass is melted at 1100° C. and by setting a temperature in the nozzle NZ at 900° C. and a target setting temperature in the upper and the lower molds 11 and 12 (namely the target setting temperature on the transfer surfaces) at around 450 to 500° C., the glass lens 100 can be obtained in a desirable condition.

As above, in the manufacturing method of the glass lens 100 related to the present embodiment, surface aligning and centering for positioning is not necessary, and the positioning datum surface 102b can be molded accurately and unfailingly in a relatively simple way. Namely, the manufactured glass lens 100 can be used as a lens which does not requires centering.

As above, while the manufacturing methods of the glass lens 100 related to the present embodiment have been described, the manufacturing method of the glass lens 100 is not limited to the methods thereof.

In the present embodiment, while the outer shape regulation frame 3 is fixed and integrated with the upper mold 1 by fitting over the upper mold 1, the outer shape regulation frame 3 can be moved independently from the upper mold 1. Whereby, various shapes of the side surfaces 103 of the glass lens 100 and various methods of bringing out the glass lens 100 in the bringing out process can be available. Further, in addition to the outer shape regulation frame 3 installed at the upper mold 1, a regulation frame in a shape of a cylinder having an inner diameter larger than that of the outer shape regulation frame 3 can be disposed at the lower mold 2 side so as to serve a part of the function of the outer shape regulation frame 3.

Also, the taper angle e of the outer shape regulation surface 13 in the taper shape which broadens towards the lower mold 2 can be determined appropriately within the range of 0° to 45°.

Further, as the material of the outer shape regulation frame 3, besides the ultrahard alloy, silicon carbide series or silicon nitride series ceramic can be used. The linier expansion coefficient of the silicon carbide series ceramic is around 4.0×10^{-6 [1}/K] and the linier expansion coefficient of the silicon nitride series ceramic is around 3.4×10^{-6 [1}/K]. The above expansion coefficients are smaller compared to that of the phosphate series glass.

In addition, to purge air, besides the gap SD1, gaps can be provided at portions where the gaps do not affect molding of the glass lens 100.

What is claimed is:

1. A lens manufacturing method, comprising steps of:
preparing a lower mold having a lower mold surface to form a first lens surface of a lens representing an object of manufacturing, an upper mold having an upper mold surface to form a second lens surface of the lens and an outer shape regulation frame having an outer shape regulation surface to form an outer shape including a side surface of the lens;
dropping a melt glass droplet on the lower mold surface in a state where the lower mold, the upper mold and the outer shape regulation frame are heated, which represents a dropping process; and
molding the melt glass droplet on the lower mold with pressure by moving the upper mold and the outer shape regulation flame close to the lower mold in a state where the lower mold surface and the upper mold surface face each other after dropping the melt glass droplet, which represents a forming process.

2. The lens manufacturing method of claim 1, wherein a curvature of the first lens surface is greater than that of the second lens surface.

3. The lens manufacturing method of claim 1, wherein an upper edge of the outer shape regulation surface of the outer shape regulation frame and a lower edge of a circumferential surface of the upper mold are disposed closely.

4. The lens manufacturing method of claim 3, wherein the upper edge of the outer shape regulation surface of the outer shape regulation frame and the lower edge of the circumferential surface of the upper mold are disposed having a predetermined gap in between.

5. The lens manufacturing method of claim 1, wherein the outer shape regulation surface of the outer shape regulation frame is a taper surface which broadens down below.

6. The lens manufacturing method of claim 5, wherein an obliquity angle of the taper surface is 0° to 45°.

7. The lens manufacturing method of claim 1, wherein a temperature of the melt glass droplet is progressively lowered from the dropping process to the forming process.

8. The lens manufacturing method of claim 1, wherein an expansion coefficient of the outer shape regulation frame is smaller than an expansion coefficient of the melt glass droplet after hardening.

9. The lens manufacturing method of claim 1, wherein the outer shape regulation frame is configured with an ultrahard alloy.

10. The lens manufacturing method of claim 1, wherein the outer shape regulation frame is fixed at a barrel section of the upper mold.

11. The lens manufacturing method of claim 1, further comprising a step of:
bringing out the lens molded by relieving pressure applied onto the lower mold and the upper mold after the molding process, which represents a bringing out process.
